(19) United States
(12) Patent Application Publication
(10) Pub. No.: US 2014/0047308 A1
(43) Pub. Date: Feb. 13, 2014

(54) PROVIDING NOTE BASED ANNOTATION OF CONTENT IN E-READER

(71) Applicant: MICROSOFT CORPORATION, Redmond, WA (US)

(72) Inventors: Sergey Chub, Redmond, WA (US); Raman Narayanan, Seattle, WA (US); Ming Liu, Bellevue, WA (US); Radoslav Nickolov, Seattle, WA (US); Wei Zeng, Sammamish, WA (US)

(73) Assignee: Microsoft Corporation, Redmond, WA (US)

(21) Appl. No.: 13/684,011

(22) Filed: Nov. 21, 2012

Related U.S. Application Data
(60) Provisional application No. 61/681,094, filed on Aug. 8, 2012.

(51) Int. Cl. G06F 17/24

(52) U.S. Cl. CPC G06F 17/241; G06F 17/24
USPC 715/201; 715/230

(57) ABSTRACT

An e-reader application provides a note based annotation of content in an e-reader. A user action to annotate the content initiates a note pane to capture a note. The note includes variety of types including text, ink, snippet, audio recording, and photo. The note is captured in the note pane which is configured according to the note type. The note is stored in a platform-agnostic in a cloud storage. A local cache also maintains the note for offline usage. The note is anchored to the content using an anchor marker placed within proximity to a selection associated with the note in the content.

### CROSS REFERENCE TO RELATED APPLICATIONS

This application claims the benefit of U.S. Provisional Patent Application Ser. No. 61/681,094 filed on Aug. 8, 2012. The disclosures of the provisional patent application are hereby incorporated by reference tor all purposes.

### BACKGROUND

Mobile computing has transformed media consumption across markets. Miniaturization across product generations has enabled more functionality to be accomplished by smaller devices. A modem smartphone has mom computing capacity than desktop computer a few years ago. Mature product processes have also enabled advances in technology to be integrated to automated production seamlessly. Extensive automation has led to inexpensive components. Inexpensive components have enabled manufacturing of inexpensive mobile devices providing functionality on the go.

Ubiquitous network infrastructures have enabled inexpensive mobile devices to share and consume content on the go. Investing in network infrastructure in recent times has provided network access to variety of devices in a wide variety of locations. Many users are enabled to access their content through personal devices in unimagined locations until modem times. As a result, consumption of content has increased significantly. Mote users choose to consume media through personal devices than in the past. However, electronic media is at a disadvantage compared to traditional sources. Traditional sources like books enable a user to annotate content through a simple process such as writing. In contrast, content interaction through personal, devices has to be accomplished through the personal device. Providing a user with a decent user experience to annotate content has been a challenge for modem products. Modem solutions usually end up trading simple features of writing while implementing annotation solutions for electronic content.

### SUMMARY

This summary is provided to introduce a selection of concepts in a simplified form that are former described below in the Detailed Description. This summary is not intended to exclusively identity key features or essential features of the claimed subject matter, nor is it intended as an aid in determining the scope of the claimed subject matter.

Embodiments are directed to providing a note based content annotation in an e-reader. According to some embodiments, an application of an e-reader device may detect a user action to annotate content with a note. A note pane may be launched to capture the note based on the user selection of content (e.g., text) or user input of marking may be started to be taken on top of the actual book either when the user brings a pen in close to the tablet or when he/she explicitly requests this modal change if the device does not support pen input. The note pane may he configured according to a selected note type. The note may be stored in a platform-agnostic format upon detecting an end to capturing the note. The note may he presented through a user interface of the e-reader device. Next, the note may be anchored to the content. Anchoring may be accomplished using a tree based document standard. In the case of ePub/HTML, the document is tree based. The tree based document standard may maintain functionality to display notes when presenting the annotated content across platforms. So, the anchoring algorithm may take advantage of that. However, anchoring in general is not limited to a tree based document standard.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates an example architectural diagram of providing a note based annotation of content in an e-reader according to some embodiments;

FIG. 2 illustrates a quick note example according to embodiments;

FIG. 3 illustrates a full page note example according to embodiments;

FIG. 4 illustrates an annotation authoring example according to embodiments;

FIG. 5 Illustrates examples of alternative notes to annotate content according to embodiments;

FIG. 6 illustrates an example of a markup feature according to embodiments;

FIG. 7 illustrates another example of a markup feature according to embodiments;

FIG. 8 is a networked environment where a system according to embodiments may be implemented;

FIG. 9 is a block diagram of an example computing operating environment, where embodiments may be implemented; and

FIG. 10 illustrates a logic flow diagram for a process providing a note based annotation of content in an e-reader according to embodiments.

### DETAILED DESCRIPTION

As briefly described above, content may be annotated using a note in an e-reader device. An application of the e-reader device may initiate a note pane to capture the note upon a user action to annotate the content with the note. The captured note may be stored in a platform-agnostic format and anchored to the content.

In the following detailed description, references are made to the accompanying drawings that form a part hereof and in which are shown by way of illustrations specific embodiments or examples. These aspects may be combined, other aspects may be utilised, and structural changes may be made without departing from the spirit or scope of the present disclosure. The following detailed description is therefore not to be taken in a limiting sense, and the scope of the present disclosure is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or Implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flask drive, a floppy disk, or a compact disk, and comparable media.

Throughout this specification, the term “platform” may be a combination of software and hardware components for providing a note based annotation of content in an e-reader. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

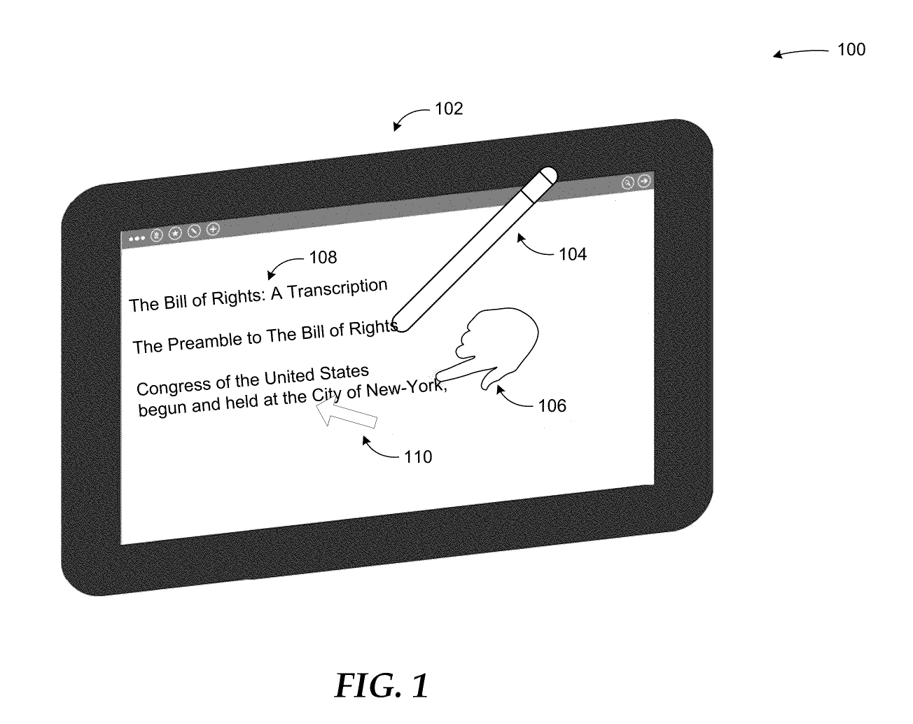

FIG. 1 illustrates an example architectural diagram where content may be annotated using a note in an e-reader according to embodiments. The components and environments shown in diagram 100 are for illustration purposes. Embodiments may be implemented in various local, networked, cloud-based and similar computing environments employing a variety of computing devices and systems, hardware and software.

An “e-reader” device such as a tablet 102 may host an application providing content 108 to a user. Such an application may be called an e-reader application, which may be a locally installed and executed application receiving content (e.g., e-books, documents, etc.) through wired or wireless networks. The e-reader application may also be a hosted service provided by one or more servers and accessed by a user through the e-reader device (e.g., tablet 102). Content may be any type of consumable data including but not exclusive to text, audio, video, graphic, etc. Content may also include media combinations presented in a standardized format (i.e.: a web page.)

A user may interact with the content 108 through a variety of control devices. The tablet 102 may be enabled to detect a pen 104, a touch 106, and a mouse 110 based input. The application may customize a user experience according to the detected input type. In an example scenario, a note pane may be launched when detecting the pen 104 over the content 108. Similarly, a touch based input may be analyzed based on length and direction of the touch to determine launching of the note pane. Furthermore, the note pane may be launched based on mouse input according to predetermined scenario such as a right click.

A note such as an ink may be formatted in a standardized format. For example, Ink Serialized Format (ISF) may be used. An anchor marker may be inserted into the content to anchor the note to an associated portion of the content in a location within proximity to the portion. The anchor marker may be inserted into the document tree directly in the case of the tree based document. In addition, upon detecting ink as the note, the ink may be processed for calligraphy improvement during creation of the ink by the user.

Embodiments are not limited to implementation in a tablet 102. An application according to embodiment may enable a user to annotate content with a note in other platforms. A user may he enabled to provide the note in any device capable of displaying the content. A touch enabled device (although preferable) is not necessary. A user may be enabled to take a note over content using a standard mouse and keyboard interface.

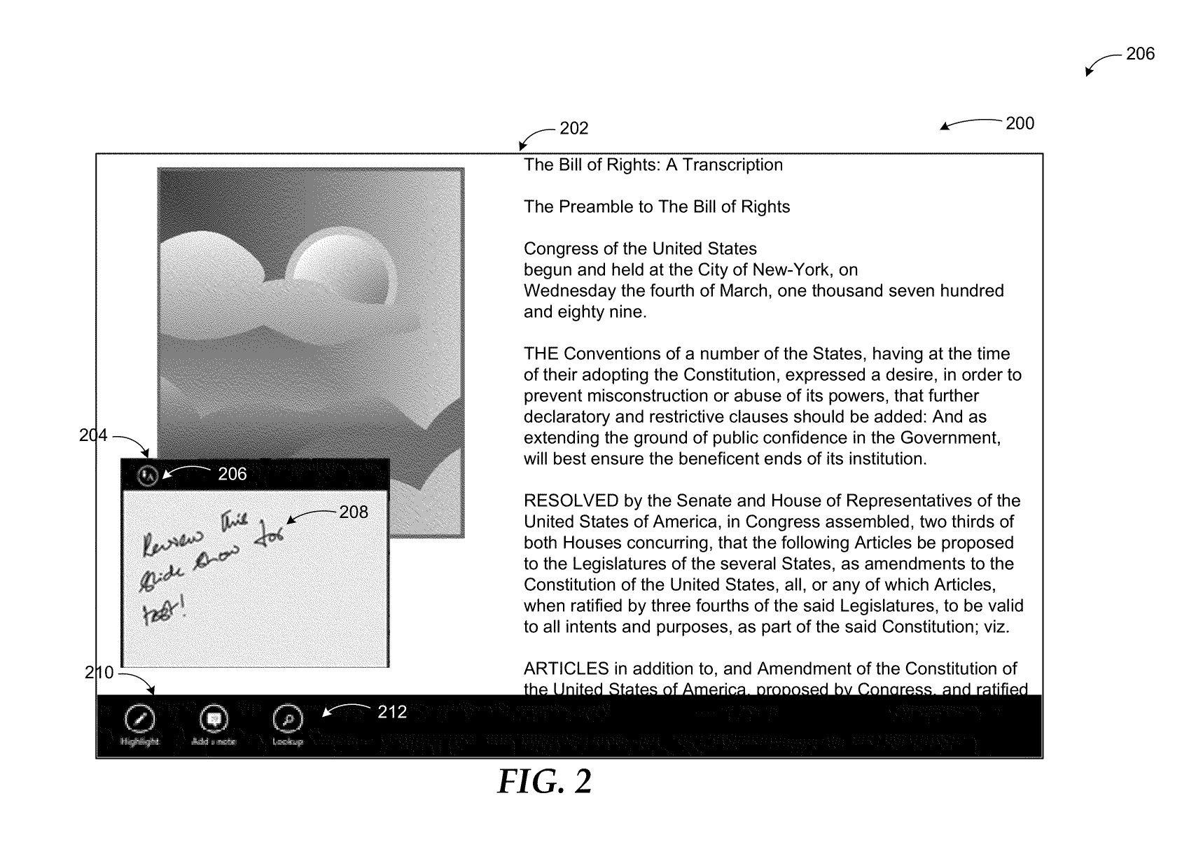

FIG. 2 illustrates a quick note example according to embodiments. Diagram 200 displays content annotated with a quick note.

A user may initiate a quick note pane 204 by selecting content displayed by a user interface 202 of an application providing e-reader services. Ink based note may be a default note type when using a quick note pane 204. A toggle control 206 may switch note type from ink to text. Ink based note type may include any drawing that may be detected by the application. Drawings may include hand writings, figures of objects, etc.

The note pane may also be launched using a control 212 displayed in a control menu 210 of the application. The control menu may host launchers for highlighting and note taking functionality. The control menu may also include a control for a search function.

The quick note pane 204 may be closed upon another action detected away from the note pane. The application may place a marker near content of interest as the anchor. The content of interest may be a selection within the content associated with the note. The note may be displayed upon initiating the marker. Alternatively, the note may be displayed upon a right click action on the content of interest and selecting a launch action from a displayed command menu.

Additional features may include ink anywhere (i.e.: capture a note without a pane), note types other than text (i.e.: image), export note, and send to friend for importing. The application may also provide features to set a configuration for the note including: background, font type, font size, color, pen tip width, ink color, highlight type, underline, color, width, etc.

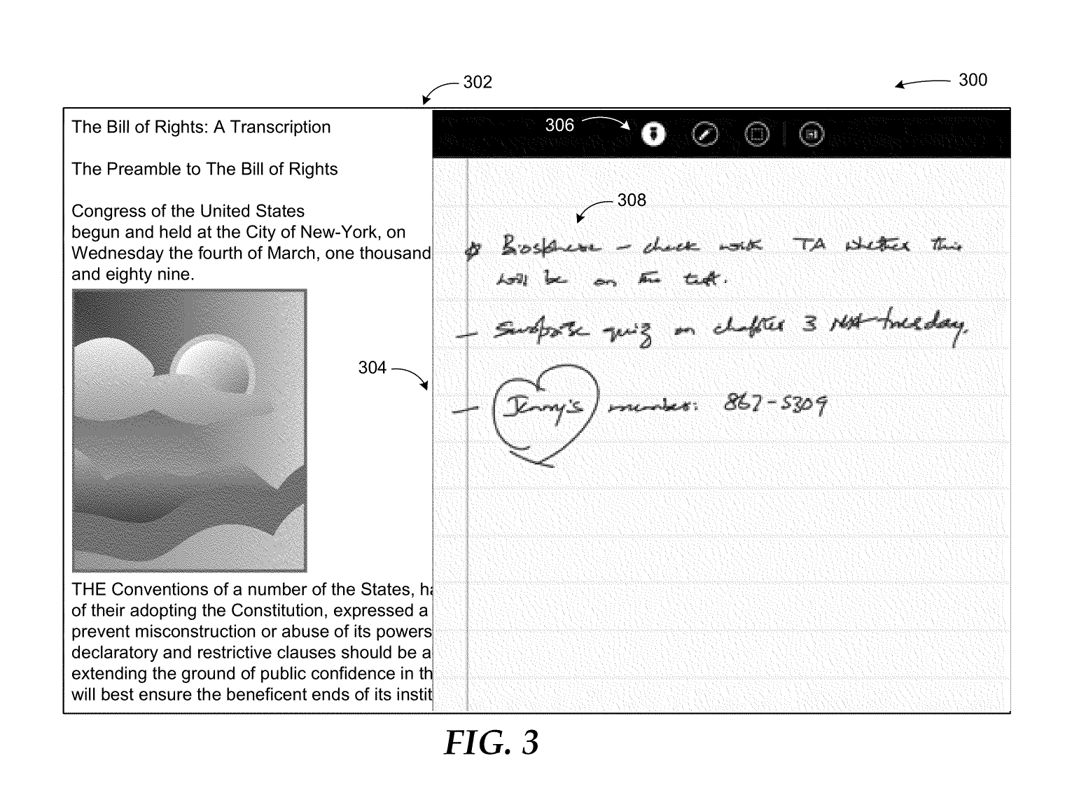

FIG. 3 illustrates a full page note example according to embodiments. Diagram 300 displays a full page note pane to capture detailed notes for annotation of the content.

A full page note may enable a user to anchor detailed notes to the displayed content 302. The user may initiate the full page note pane 304 by selecting an annotate control from a command bar of the application. Ink based note type may be a default setting for a full page note 304.

Ink strokes and/or groups 308 created in the full page note pane 304 may be selectable using a lasso select control from controls 306. The selected strokes and/or groups may be moved or deleted. The full page note pane 304 may be dismissed by selecting a close control from the command bar.

The user may annotate the content with a variety of note types using the full page note pane 304. The user may add a voice recording. The user may insert an image and/or a video into the note. The user may add search results, a link, and a web page into the note. The user may also add nested notes into the note. The nested notes may be anchored in other content.

A quick hide control may reveal the content underneath the full page note. The user may select a portion of the content and copy it into the full page note using a lasso control. In addition, the user may export the full page note to a document processing application. Furthermore, settings for background, font, font size, color, pen tip width, ink color, highlight type, color, and width of the note may be set through controls in the full page note content 304.

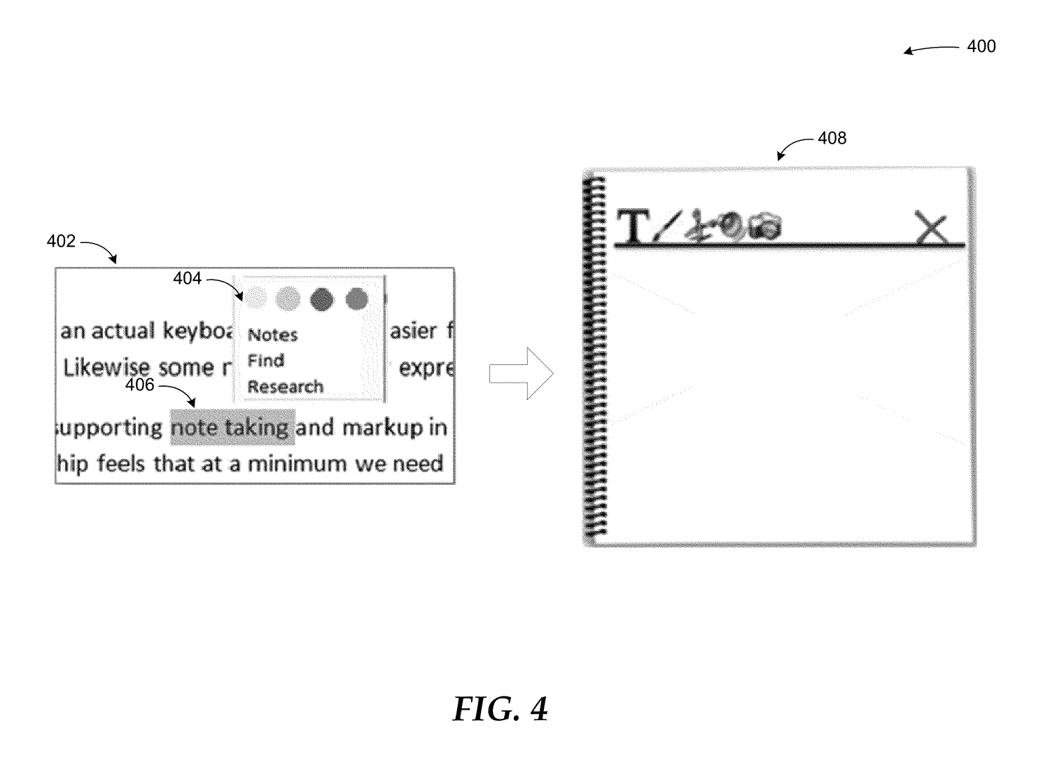

FIG. 4 illustrates an annotation authoring example according to embodiments. Diagram 400 displays a selection action initiating a note pane 408 to capture notes.

An application according to embodiments may initiate the note pane 408 upon a user action. The user action may be a selection of text from the content 402. An example may include a mouse input highlighting the selected test 406. A touch or pen input may select text according to detected patterns such as a tap and hold.

Alternatively, a context menu 404 may be displayed upon selecting the text 406. The context menu may have a control to initiate the note pane 408. Another user action on the context menu control may launch the note pane 408.

The note pane 408 may be displayed on the right or left of the selected test 406. The location of the note pane may be determined according to available space between the selection and an edge of the display device. The note pane may be displayed in a side with larger space between the selection and the edge. The note pane may be resizable down to a minimum predetermined size to maintain visibility of displayed controls. The note pane may be resided and relocated to match a size and a location configuration of the note when redisplaying the note.

The note pane may provide text baaed note type by default. A user may change the note type to text, ink, snippet, audio, or photo through a control associated with the note type within the note pane.

The note pane may customize its display surface according to the selected note type. The note pane may display lines while using a text based note type. The note pane may display vertical scroll bars on demand while hosting text based note. The note pane may display horizontal and vertical lines in a grid while using an ink based note type. Vertical and horizontal scroll bars may be displayed while using the ink based note type. The note pane may display linen paper background when using snippet, audio, or photo based note type. Vertical scrollbars may be displayed on demand. In addition, another user action on the content may dismiss the note paste. Furthermore, the note may be saved to a cloud based storage and the anchor may be inserted into a location in the content associated with the note.

According to some embodiments, a user may change a color of a highlight on a selection in the note by activating a highlight color control in the context based menu 404. In addition, the note pane may be configured for a text based note type by default. The note pane may provide copy and paste functionality. Controls for changing font attributes including type, color and size may be displayed in the note pane. Vertical scroll bars may be provided on demand when inserted text may exceed display size.

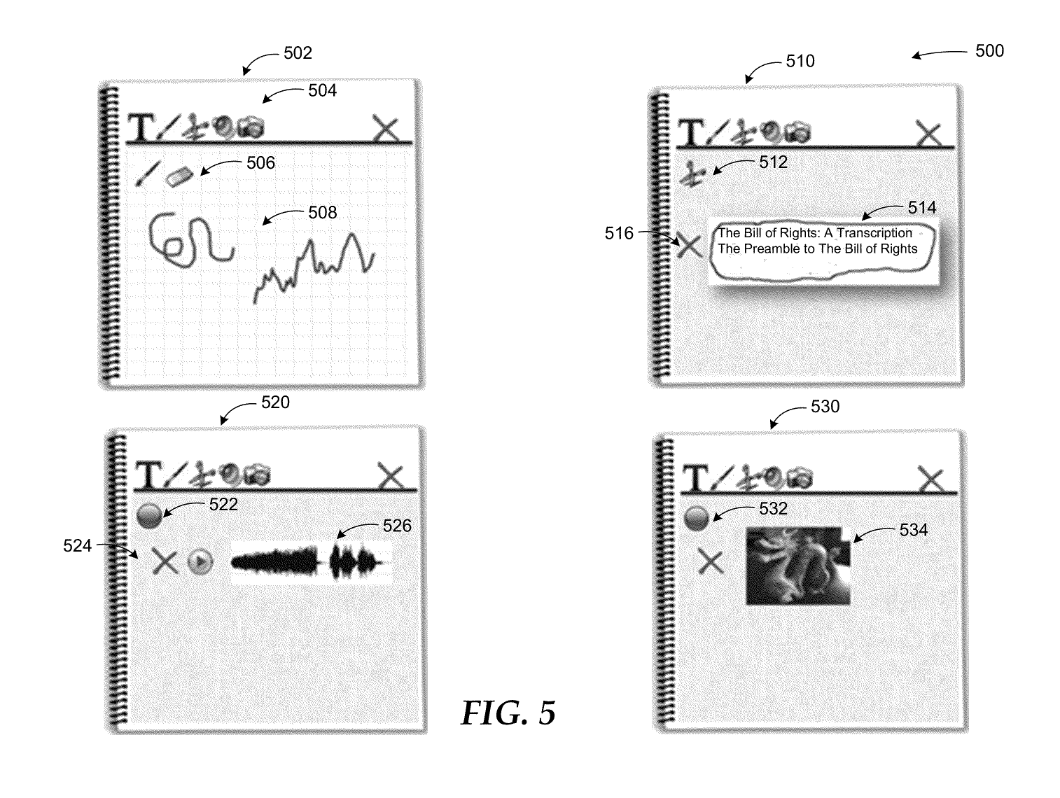

FIG. 5 illustrates examples of alternative notes to annotate content according to embodiments. Diagram 500 displays example note panes capturing varying note types.

The note pane 502 may be configured for an. ink based note type. The note pane 502 may display additional controls 506 when using ink based note type. The note pane 502 may display brush and eraser controls 506. In addition, ink strokes 508 may be registered during mouse, pen, or touch down action and stopped when released. Controls may be provided for ink thickness, stroke style, or color. Shape or handwriting may be automatically recognized. Ink strokes 508 may be erased using an eraser control. Furthermore, the note pane may display vertical and horizontal scrollbars to browse the canvas.

The note pane 510 may be configured for a snippet based note type. The note pane 510 may display a snipping control 512. The note pane 510 may be hidden upon activation of the control 512. Content may be displayed with a transparent filter and a cursor. The application may detect the user drawing a rectangle around a portion of the content while utilizing the cursor. Upon release of the cursor, a snippet 514 representing the portion in the rectangle may be transferred to the note pane. Full size and aspect ratio of the snippet may be maintained during the paste operation. Additionally, the note pane may display vertical and horizontal bars as needed to enable the user to scroll through the snippet. The snippet may be stored as the note.

Snippets may be organized as horizontal rows with lined dividers in between each snippet. The snippets may not be reorganized or moved. In addition, the snippets may be auto-arranged in same sequence that the clippings appear in the content. A delete control 516 may be displayed adjacent to the snippet 514 to enable a user to delete the snippet. Each activation of the delete control 516 may initiate a confirmation prompt.

The note pane 520 may be configured for an audio recording based note type. The note pane 520 may display a record control 522 to initiate an audio recording 526. A recording may be displayed in rows similar to the note pane capturing snippets. The recording may be shown as a waveform graphic. In addition, the recording may be displayed using metadata showing date, time, and duration information. A delete control 524 may be displayed adjacent to the recording 526. Activation of the delete control may initiate a confirmation prompt.

The note pane 530 may display a record control 532 to initiate a photo capture. A photo 534 may be displayed in rows similar to the note pane capturing snippets. In addition, the photo 534 may be displayed as a thumbnail graphic along with metadata showing date and time information of the capture. A delete control may be displayed adjacent to the photo 534. Activation of the delete control may initiate a confirmation prompt.

According to some embodiments, a user may select an anchor marker to edit a note. The note pane may display by default the recent note type recorded for the anchor marker. In addition, a user may insert multiple notes to an anchor. Notes using multiple note types may be anchored to one anchor marker. In an example scenario, a user may select a sentence in content and insert a test based note, an ink based note, and an audio based note. The notes may be displayed in one note pane and .may be referenced by one anchor point in the content.

The user may have access to three entry points to initiate a note pane. The application may detect a second user action selecting a portion of the content. The selection may launch a context menu. The application may initiate the note pane upon a third user action selecting a control associated with the pane from the context menu. In addition, selection of an existing anchor marker may launch the note pane. Furthermore, a user may initiate the note pane through a search control to find the note. The search control may display a results list including the note. A user action selecting a link to the note in the results list may initiate the note pane.

Created or edited notes may be stored in cloud based storage. Offline usage may be handled by local storage. Changes detected during offline use may be posted to the cloud based storage upon restoration of connectivity.

Notes may be transmitted using email. Alternatively, if a user does not have access to an e-reader device, content may be transmitted along with the note. The content may also be transmitted as a picture. Alternative transmission methods such as Bluetooth or instant messaging may also be used.

Highlights and anchor markers may be displayed in search results to inform about presence of notes. Multiple search results about an object in the content may distinguish the object from the annotated object (object with notes).

A summary section of the content may contain links to the notes within the content. A seek bar may contain vertical tick marks in the same color as an initial note within a page of the content.

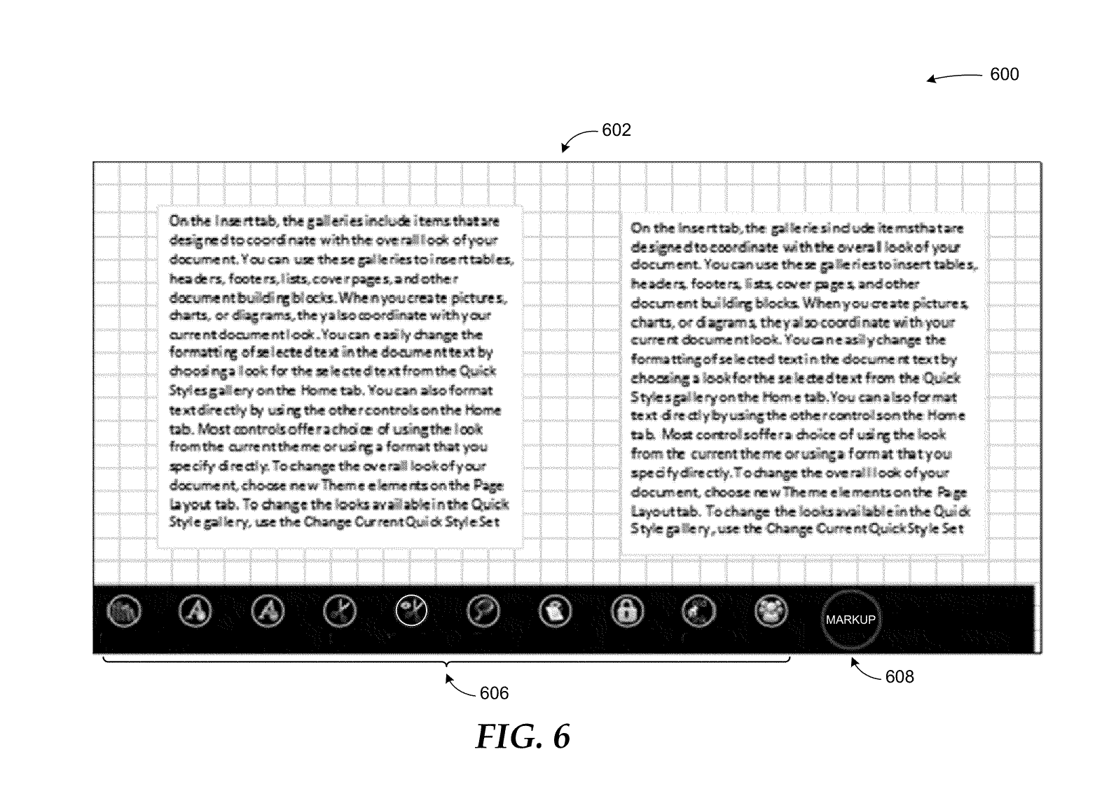

FIG. 6 illustrates an example of a markup feature according to embodiments. Diagram 600 displays a markup feature enabling a user to draw and highlight directly on content.

A user with a pen may initiate annotation of a full page content by drawing ink or highlighting using the pen on a display 602 of an e-reader device. Alternatively, an application, according to embodiments, may present a markup control 608 in a control bar 606 to initiate ink capture and highlighting on full page content.

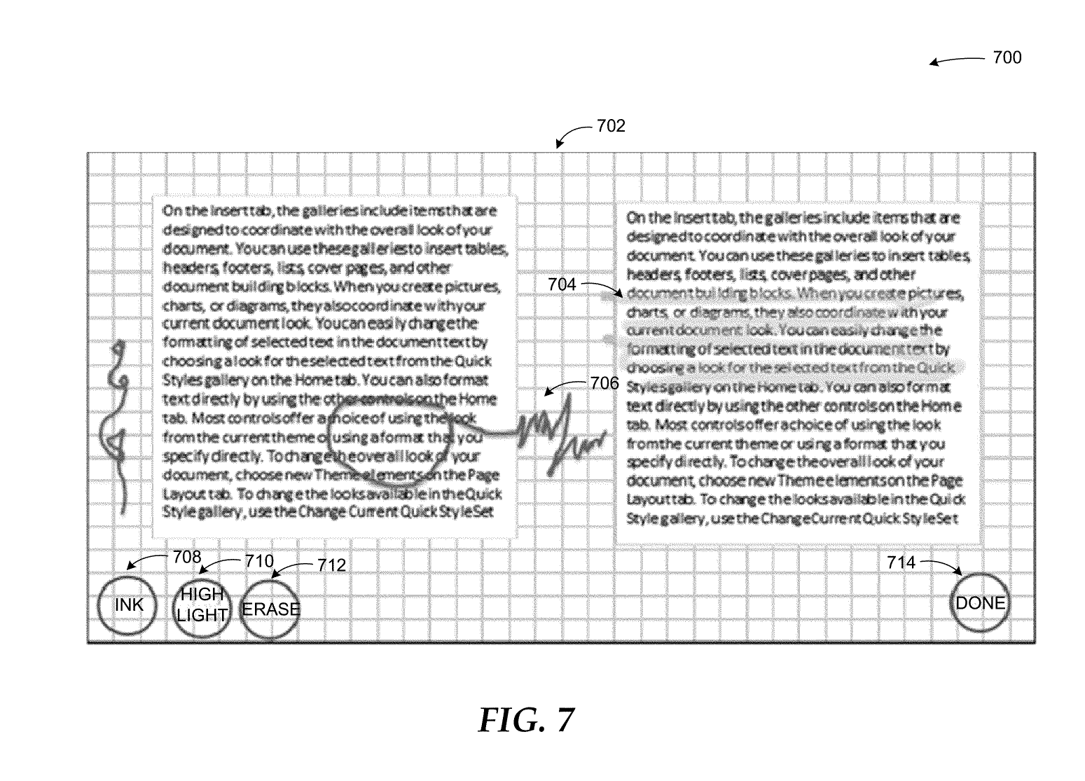

FIG. 7 illustrates another example of a markup feature according to embodiments. Diagram 700 displays a full content where a user may markup the content using ink or highlighting.

A user may work with ink and highlighting tools to draw in freeform on the content 702. A highlighter tool may be an ink tool with thicker stroke and transparency. The user may click a control 714 to exit markup and return to reading the content 702. The application may detect a user action on an ink control 708 to draw ink 706 on the content. A drawn ink may be stored and anchored in a location within proximity to a portion of the content associated with the note. Another user action may be detected on a highlight control 710 to draw highlights 704 on the content. The highlight may he stored and anchored in a location within proximity to a portion of the content associated with the note. Erase control 712 may enable art eraser tool to erase the ink. and highlighting.

An anchor marker may be inserted at the end of a selected text. The anchor marker may follow the text through font size changes and screen resolution changes. The markup feature may also deposit an anchor marker in the content at a start of a displayed page when the page was authored. The marker may be invisible if the user is reading the content on the same resolution and same test scale as the tune the markup was created.

If the text scale or screen resolutions are different than the markup original creation metadata, then the user may see the in-line anchor marker in the content or an icon/button in the margin area. There may be several of these on any given screen per every full page annotation made by the user on any portion of the text visible on the current page. Initiating the marker may display the markup in a pop-out window such that the shown annotation is presented on a page identical to the one where the annotation was collected. A link to the markup may also be displayed in a view of the note pane.

According to some embodiments, a pane to show a list of all notes/annotations collected for the currently opened book may be presented. Such a pane may be used to navigate to the page where each annotation was taken (e.g., when user clicks on the entry for the annotation in the list).

According to other embodiments, a highlighter may snap to text on a page of the content. An assortment of color choices may be offered for ink and highlighter. In addition, a markup may be displayed when the reading page is shrunk to display a side panel.

A user may maintain the ability to interact with content when markup is overlaid on top of the reading view. A pop-up markup display may be a read-only window or view of the markup. It may be a screen shot.

The example scenarios and schemes in FIG. 2 through 7 are shown with specific components, data types, and configurations. Embodiments are not limited to systems according to these example configurations. Providing a note based annotation of content in an e-reader may be implemented in configurations employing fewer or additional components in applications and user interfaces. Furthermore, the example schema and components shown in FIG. 2 through 7 and their subcomponents may be implemented in a similar manner with other values using the principles described herein.

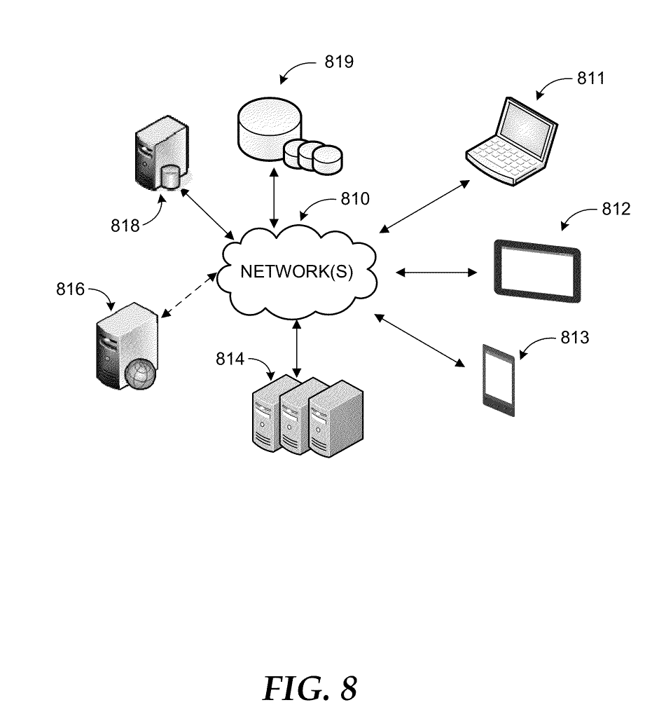

FIG. 8 is a networked environment, where a system according to embodiments may be implemented. Local and remote resources may be provided by one or more servers 814 or a single server (e.g. web server) 816 such as a hosted service. An application may execute on individual computing devices such as a smart phone 813, a tablet device 812, or a laptop computer 811 (‘client devices’) and communicate with cloud based storage through network(s) 810.

As discussed above, an e-reader application may detect a user action to annotate content with a note. A note pane associated with a note type may be initiated to capture the note. The note may be stored in a platform-agnostic format upon completing the capture. Some example formats may include cascading style sheets (CSS) or JSON. The note may be anchored to the content. Client devices 811-813 may enable access to applications executed on remote server(s) (e.g. one of servers 814) as discussed previously. The server(s) may retrieve or store relevant data from/to data store(s) 819 directly or through database server 818.

Network(s) 810 may comprise any topology of servers, clients, Internet service providers, and communication media. A system according to embodiments may have a static or dynamic topology. Network(s) 810 may include secure networks such as an enterprise network, an unsecure network such as a wireless open network, or the Internet. Network(s) 810 may also coordinate communication over other networks such as Public Switched Telephone Network (PSTN) or cellular networks. Furthermore, network(s) 810 may include short range wireless networks such as Bluetooth or similar ones. Network(s) 810 provide communication between the nodes described herein. By way of example, and not limitation, network(s) 810 may include wireless media such as acoustic, RF, infrared and other wireless media.

Many other configurations of computing devices, applications, data sources, and data distribution systems may be employed to provide a note based annotation of content in an e-reader. Furthermore, the networked environments discussed in FIG. 8 are for illustration purposes only. Embodiments are not limited to the example applications, modules, or processes.

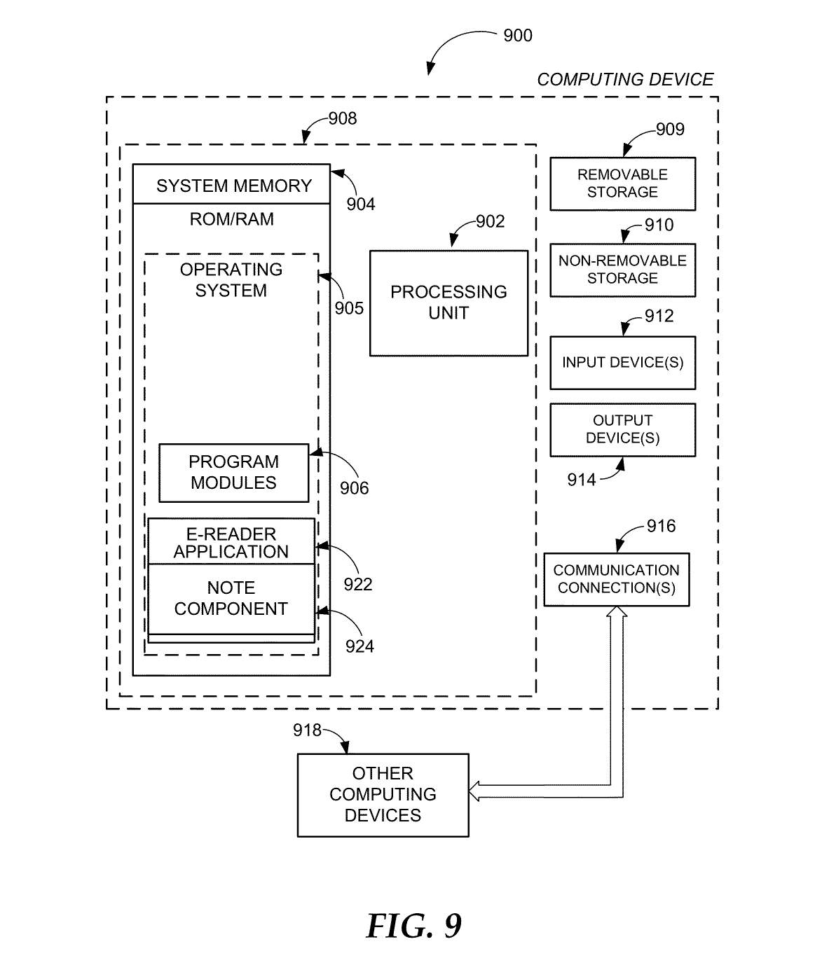

FIG. 9 and the associated discussion are intended to provide a brief, general description of a suitable computing environment in which embodiments may be implemented. With reference to FIG. 9, a block diagram of an example computing operating environment for an application according to embodiments is illustrated, such as computing device 900. In a basic configuration, computing device 900 may include at least one processing unit 902 and system memory 904. Computing device 900 may also include a plurality of processing units that cooperate in executing programs. Depending on the exact configuration and type of computing device, the system memory 904 may be volatile (such as RAM), non-volatile (such as ROM, flash memory, etc.) or some combination of the two. System memory 904 typically includes an operating system 905 suitable for controlling the operation of the platform, such as the WINDOWS® and WINDOWS PHONE® operating systems from MICROSOFT CORPORATION of Redmond, Wash. The system memory 904 may also include one or more software applications such as program modules 906, an e-reader application 922, and a note component 924.

An e-reader application 922 may detect a user action to annotate content with a note. The note component 924 may launch a note pane to capture the note. The note may be stored by the note component 924 upon completion of the capture. The note component 924 may anchor the note to a location associated with the content. This basic configuration is illustrated in FIG. 9 by those components within dashed line 908.

Computing device 900 may have additional features or functionality. For example, the computing device 900 may also include additional data storage devices (removable and/or non-removable) such as, for example, magnetic disks, optical disks, or tape. Such additional storage is illustrated in FIG. 9 by removable storage 909 and non-removable storage 910. Computer readable storage media may include volatile and nonvolatile, removable and non-removable media implemented in any method or technology for storage of information, such as computer readable instructions, data structures, program modules, or other data. Computer readable storage media is a computer readable memory device. System memory 904, removable storage 909 and non-removable storage 910 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can he used to store the desired information and which can be accessed by computing device 900. Any such computer readable storage media may be part of computing device 900. Computing device 900 may also have input device(s) 912 such as keyboard, mouse, pen, voice input device, touch input device, and comparable input devices. Output device(s) 914 such as a display, speakers, printer, and other types of output devices may also be included. These devices are well known in the art and need not be discussed at length here.

Computing device 900 may also contain communication connections 916 that allow the device to communicate with other devices 918, such as over a wireless network in a distributed computing environment, a satellite link, a cellular link, and comparable mechanisms. Other devices 918 may include computer device(s) that execute communication applications, storage servers, and comparable devices. Communication connection(s) 916 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be co-located with each other, but each can be only with a machine that performs a portion of the program.

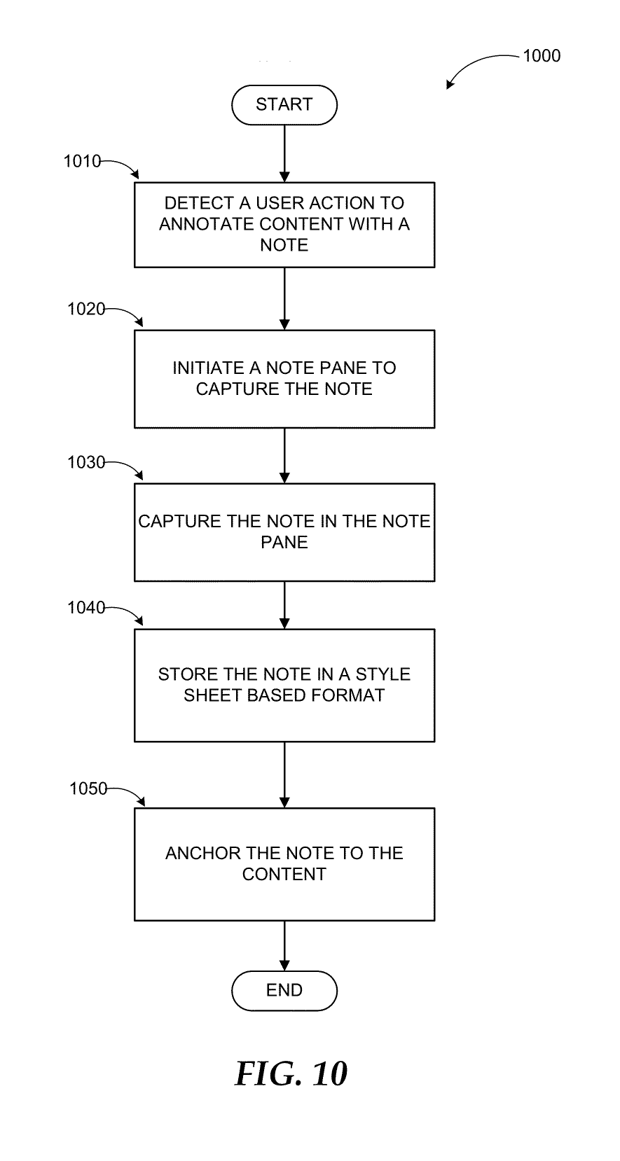

FIG. 10 illustrates a logic flow diagram for a process providing a note based annotation of content in an e-reader according to embodiments. Process 1000 may be implemented by an e-reader application in some examples.

Process 1000 may begin with operation 1010 where the e-reader application may detect a user action to annotate content with a note. The user action may include a selection of a portion of the content. The application may initiate a note pane to capture the note at operation 1020. The note pane may include controls to manage the note type and capture criteria. At operation 1030, the note may be captured in the note pane. Note pane may be configured to accommodate size and location of the captured note. At operation 1040, the note may be stored in a style sheet based format upon detecting an end to capturing. The style sheet based format may enforce uniformity and cross platform operability of annotated content. The note may be anchored to the content at operation 1050. The anchor marker may be placed in a location associated with the annotated content.

Some embodiments may be implemented in a computing device that includes a communication module, a memory, and a processor, where the processor executes a method as described above or comparable ones in conjunction with instructions stored in the memory. Other embodiments may be implemented as a computer readable storage medium with instructions stored thereon for executing a method as described above or similar ones.

The operations included in process 1000 is for illustration purposes. Providing a note based annotation of content in an e-reader, according to embodiments, may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed on a computing device for providing a note based annotation of content in an e-reader, the method comprising:
detecting an annotation action on the content;
initiating a note pane to capture a note;
capturing the note in the note pane;
storing the note in a platform-agnostic format upon detecting an end to capturing; and
anchoring the note to the content.

2. The method of claim 1, further comprising:
detecting a selection of another portion of the content;
launching a context menu; and
detecting activation of a control of the context menu associated with launching the note pane.

3. The method of claim 1, further comprising:
launching the note pane in response to selection of an existing anchor marker.

4. The method of claim 1, further comprising:
initiating the note pane through a search control displaying a results list and a selection of a link to the note in the results list.

5. The method of claim 1, further comprising:
highlighting a portion of the content associated with the note using a color control displayed in a contest menu; and
changing a color of the of the highlighted portion using another color control displayed in the context menu.

6. The method of claim 1, further comprising:
configuring the note pane for a text based note type by default;
providing copy and paste functionality through the note pane;
displaying controls for changing font attributes including: a font type, a font color and a font size of the note; and
providing a vertical scroll bar on demand to scroll through the note in the note pane.

7. The method of claim 1, further comprising:
configuring the note pane for an ink based note type;
displaying a brush control and an eraser control;
providing controls for changing ink attributes including: a thickness of the ink, a stroke style, and a color of the ink;
automatically processing the ink as the note through at least one of: a handwriting recognition and a shape recognition; and
displaying a vertical scroll bar and a horizontal scroll bar to scroll through the note in the note pane.

8. The method of claim 1, further comprising:
configuring the note pane for a snippet based note type;
hiding the note pane upon activation of a snipping control displayed in the note pane;
displaying the content with a transparent filter;
detecting a user drawing a rectangle around a portion of the content;
transferring the portion as the snippet into the note pane;
maintaining a size and an aspect ratio of the snippet;
displaying a vertical scroll bar and a horizontal scroll bar to scroll through the snippet in the note pane; and
storing the snippet as the note.

9. The method of claim 8, further comprising:
organizing the snippet in a horizontal row;
placing a divider between the snippet and another snippet; and
displaying a delete control adjacent to the snippet to enable deletion of the snippet.

10. The method of claim 1, further comprising:
configuring the note pane for an audio recording based note type;
displaying a record control in the note pane to capture the audio recording as the note;
displaying the audio recording in a row with a divider placed between the audio recording and another audio recording;
showing the audio recording as a waveform graphic; and
displaying a delete control adjacent to the audio recording to delete the audio recording.

11. The method of claim 1, further comprising:
configuring the note pane for a photo based note type;
displaying a record control in the note pane to capture the photo as the note;
displaying the photo in a row with a divider placed between the photo and another photo;
showing a thumbnail graphic of the photo and metadata including at least one of: a date and a time of capturing the photo; and
displaying a delete control adjacent to the photo to delete the photo.

12. A computing device for providing a note based annotation of content in an e-reader; the computing device comprising:
a memory configured to store instructions; and
a processor coupled to the memory, the processor executing an application in conjunction with the instructions stored in the memory, wherein the application is configured to:
detect an annotation action on the content;
initiate a note pane to capture the note through a process to:
detect selection action on a portion of the content;
launch a context menu; and
detect an activation of a control of the context menu associated with launching the note pane;
capture a note in the note pane;
store the note in a platform-agnostic format upon detecting art end to capturing; and
anchor the note to the content.

13. The computing device of claim 12, wherein the application is further configured to: employ a cascading style sheet (CSS) to format the note.

14. The computing device of claim 12, wherein the application is further configured to:
insert an anchor marker into the content to anchor the note in a location within proximity to a portion of the content associated with the note;
add the anchor marker into the content using extensible markup language path language (XPath); and
employ XPath to enforce formatting of the content during insertion of the anchor marker into the content.

15. The computing device of claim 12, wherein the application is further configured to:
detect ink as a note type; and
process the ink for a calligraphy improvement during creation of the ink.

16. The computing device of claim 12, wherein the application is further configured to:
store the note in a networked storage and a local cache tor an offline usage; and
upload changes to the note during the offline usage to the networked storage upon a restoration of connectivity.

17. A computer-readable memory device with instructions stored thereon for providing a note based annotation of content in an e-reader, the instructions comprising:
detecting an annotation action on the content;
initiating a note pane to capture a note;
capturing the note in the note pane;
formatting the note in a platform-agnostic format upon detecting an end to capturing;
storing the note within a networked storage and a local cache for an offline usage; and
anchoring the note to the content.

18. The computer-readable memory device of claim 17, wherein the instructions further comprise:
detecting activation of an ink control to draw ink on a portion of the content; and
storing and anchoring the ink in a location within proximity to the portion of the content associated with the note.

19. The computer-readable memory device of claim 17, wherein the instructions further comprise:
detecting activation of a highlighting control to highlight a portion of the content; and
storing and anchoring a highlighting in a location within proximity to the portion of the content associated with the note.

20. The computer-readable memory device of claim 19, wherein the instructions further comprise:
inserting an anchor marker of the note to an end of a selected text within the content.
